(19) United States
(12) Patent Application Publication
(10) Pub. No.: US 2014/0247099 A1
(43) Pub. Date: Sep. 4, 2014

(54) APPARATUS AND METHOD FOR PREVENTING A RELAY FROM FREEZING

(71) Applicant: Lear Corporation, Southfield, MI (US)

(72) Inventors: Alberto Aragones Carrete, Valls (ES); Josep Maria Domenech, Valls (ES); Ramon Sanchez Rovira, Valls (ES); Francesc-Xavier Grau-Vidal, Tarragona (ES); Jaume Giralt-Marcé, Tarragona (ES); Joan Herrero-Sabartés, Tarragona (ES); Ildefonso Cuesta-Romeo, Tarragona (ES)

(73) Assignee: Lear Corporation, Southfield, MI (US)

(21) Appl. No.: 14/187,730

(22) Filed: Feb. 24, 2014

Related U.S. Application Data
(60) Provisional application No. 61/771,383, filed on Mar. 1, 2013.

(51) Int. Cl. H01H 50/12

(52) U.S. Cl. CPC H01H 50/12
USPC 335/156

(57) ABSTRACT

In at least one embodiment, an apparatus including a relay is provided. The relay includes a coil, a terminal, and a thermal conductive material. The coil generates heat in response to a current. The terminal includes a first contact positioned thereon. The coil and the terminal define a cavity there between. The thermal conductive material is positioned in the cavity and is in thermal communication with the coil and the first contact to transfer heat from the coil to the first contact.

### CROSS-REFERENCE TO RELATED APPLICATIONS

This application claims the benefit of U.S. provisional Application No. 61/771,383 filed Mar. 1, 2013, the disclosure of which is incorporated in its entirety by reference herein.

### TECHNICAL FIELD

Embodiments disclosed herein generally relate to an apparatus and method for preventing a relay from freezing.

### BACKGROUND

U.S. Pat. No. 4,060,847 (“the '847 patent) to Penrod provides a device for transferring heat generated within a relay. For example, the '847 patent includes a power contactor device having at least one power relay contained within an electrically insulating plastic housing. Electrical busses carrying current to the relay contacts also serve as a means for removing the heat generated by those contacts and other electrical components within the housing. On the exterior of the housing, the busses have a large surface area and transfer heat through electrically insulating but thermal conducting material, such as alumina or beryllium filled epoxy, to a heat sink. The core of the relay is in metal-to-metal contact with the heat sink.

### SUMMARY

In at least one embodiment, an apparatus including a relay is provided. The relay includes a coil, a terminal, and a thermal conductive material. The coil generates heat in response to a current. The terminal includes a first contact positioned thereon. The coil and the terminal define a cavity there between. The thermal conductive material is positioned in the cavity and is in thermal communication with the coil and the first contact to transfer heat from the coil to the first contact.

In at least another embodiment, an apparatus including a relay is provided. The relay includes a coil, a first terminal, a second terminal, and a thermal conductive material. The coil generates heat in response to a current. The first terminal includes first terminal includes a first contact positioned thereon and the coil and the first terminal define a cavity there between. The second terminal includes a second contact positioned thereon. The thermal conductive material is positioned in the cavity and is in thermal communication with the coil and at least one of the first contact and the second contact to transfer the heat from the coil to the at least one of first contact and the second contact and to prevent water condensation from condensing on the least one of the first contact and the second contact.

In at least another embodiment, a method is provided. The method includes activating a coil in a relay to generate heat from the coil. The method further includes thermally conducting the heat from the coil with a thermal conductive material. The method further includes transferring the heat from the thermal conductive material to a first terminal and transferring the heat from the first terminal to a first contact.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts various steps which outline the manner in which contacts of a relay may become inoperative due to environment;

FIG. 2 depicts a more detailed view of a relay and the manner in which contacts thereof may become inoperative due to the environment;

FIG. 3 depicts one conventional implementation of a relay and a housing;

FIG. 4 depicts a cross-sectional view of a relay in accordance to one embodiment; and

FIG. 5 depicts a method for preventing the relay from freezing in accordance to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

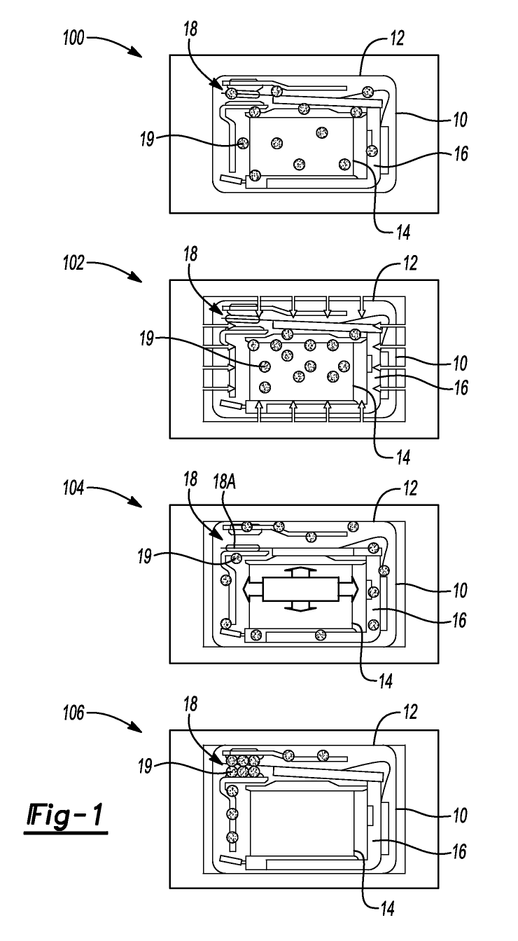

FIG. 1 depicts a various steps (e.g., 100 - 106) which outline the manner in which a relay 10 may become inoperative due to environment. It is recognized that these steps may not be successive. In general, the relay 10 includes a housing 12, a coil 14, an armature 16, and contacts 18 The coil 14, the armature 16, and the contacts 18 are positioned internal to the housing 12. These aspects will be discussed in more detail below.

Under certain driving conditions and in low temperatures, the relay 10 may collect humidity therein which may cause condensation and then subsequently freeze. This condition may cause performance issues such as relay mis-contact (e.g., contact failure due to insulated material) or delayed operation. Due to these conditions, the relay 10 may not operate and any load (not shown) coupled thereto may not be energized and hence may not be operable. This condition may prevent a vehicle from starting in the event the relay 10 is as a starting relay (or used in some other functionality to start the vehicle).

Step 100 generally illustrates that during the life of a vehicle, moisture (or water) 19 enters into the relay 10. This may occur in high-humidity environments. As shown in step 100, moisture may penetrate the housing 12 of the relay 10 and may be dispersed about various components (e.g., the coil 14, the armature 16, and the contacts 18) internal to the relay 10 when the relay 10 is either active or not active and when an exterior temperature of the vehicle is in a relatively normal state. In step 100, it is recognized that an internal temperature of the relay 10 may be relatively uniform. As such, the moisture 19 spreads uniformly in the air surrounding the different components internally with the relay 10. In this case, the relay 10 has been switched off some time ago and the temperature of the relay 10 has stabilized. In step 100, the temperature of the coil 14 within the relay 10 is similar to the temperature of contacts 18 within the relay 10.

Step 102 generally illustrates the case in which the vehicle gets very cold after being parked for some time (e.g., the relay 10 has been switched off for a long period of time or the temperature of the relay 10 has stabilized). In step 102, the relay 10 may still be inactive; however the exterior temperature may decrease from the temperature as noted in connection with the step 100 above. As such, the temperature internal to the relay 10 also decreases. This condition causes the water to locate and freeze generally about the coil 14 within the relay 10. In general, metal surfaces that directly make contact with the exterior environment tend to be cooler (or cool faster) than plastic surfaces and this condition makes metal surfaces more prone to condensation. Since the coil 14 is formed of a metal surface, condensation builds up mainly on the coil 14. In the step 102, the temperature of the coil 14 within the relay 10 is similar to the temperature of the contacts 18.

In general, water moisture spreads evenly in air. Air can hold a percentage of moisture depending on the temperature, that is, at low temperatures the percentage of moisture in the air is smaller than the percentage of moisture in the air at higher temperatures. When the temperature decreases, then, water moisture has to condense and water droplets appear in the surrounding surfaces. As this condition depends on air temperature, colder surfaces are the surfaces in which condensation occurs first, the air “near” this surface loses a humidity percentage. Then humidity homogenizes again and the air near the colder surface drops the moisture. In general, colder surfaces “attract” the moisture from the air. Moisture is generally present in the ambient air. Once temperature decreases, focalized condensation may occur in metal surfaces which contact the exterior as the metal surfaces freeze faster than the plastic surfaces.

Step 104 generally illustrates the process of when the vehicle is started again after step 102. In step 104, the relay 10 may be active and the exterior temperature may be similar to that of step 100. Because the relay 10 is active, the coil 14 generates heat since the relay 10 is enabling a flow of current to another device. For example, current flows to generate a magnetic field to catch the moving contact 18a thereby heating the coil 14 due to its ohmic value. In this case, the temperature internal to the relay 10 (or within the housing 12) increases. As seen in step 104, the water 19 migrates away from the coil 14 or spreads outwardly. In step 104, once the relay 10 switches off, the temperature of the coil 14 within the relay 10 remains high for a period of time as the coil 14 is a larger mass of metal. When the relay 10 switches off, the temperature of the coil 14 is greater than the temperature of the contacts 18.

Step 106 generally illustrates when the relay 10 is switched off, moisture is already in the relay 10 and the environment is cold, that is, external temperature is low enough to reach condensation and freezing while the relay 10 is cooling from operation. In step 106, the coil 14 and the contacts 18 now become cooler since the relay 10 has been deactivated. It is recognized that the coil 14 may require a long period of time to cool after the relay 10 has been deactivated. As shown, moisture (or water) accumulates near or about the contacts 18 and away from the coil 14 after the relay 10 has been deactivated. This is the case since the temperature of the coil 14 may be higher than that of the contacts 18 when the relay 10 is initially deactivated. For example, since the contacts 18 of the relay 10 cool faster than the remaining parts of the relay 10, the water travels to the contacts 18 (i.e., the coldest portion within the relay). In other words, water collects as droplets on the cold surface of the contacts 18 (or water condensates on the contacts) since the contacts 18 generally exhibit a lower temperature than other parts of the relay 10 soon after the relay 10 is deactivated. The water remains near the contacts 18 even after the coil 14 reaches a temperature that may be similar to that of the contacts 18.

At low temperatures, the water freezes on the contacts 18 creating a thin layer of ice on the contacts 18. Such a thin layer of ice insulates the contacts 18 and prevents the contacts 18 of the relay 10 from being closed. This condition may prevent the vehicle from being started or may also prevent some other vehicle operation that requires current to be operable.

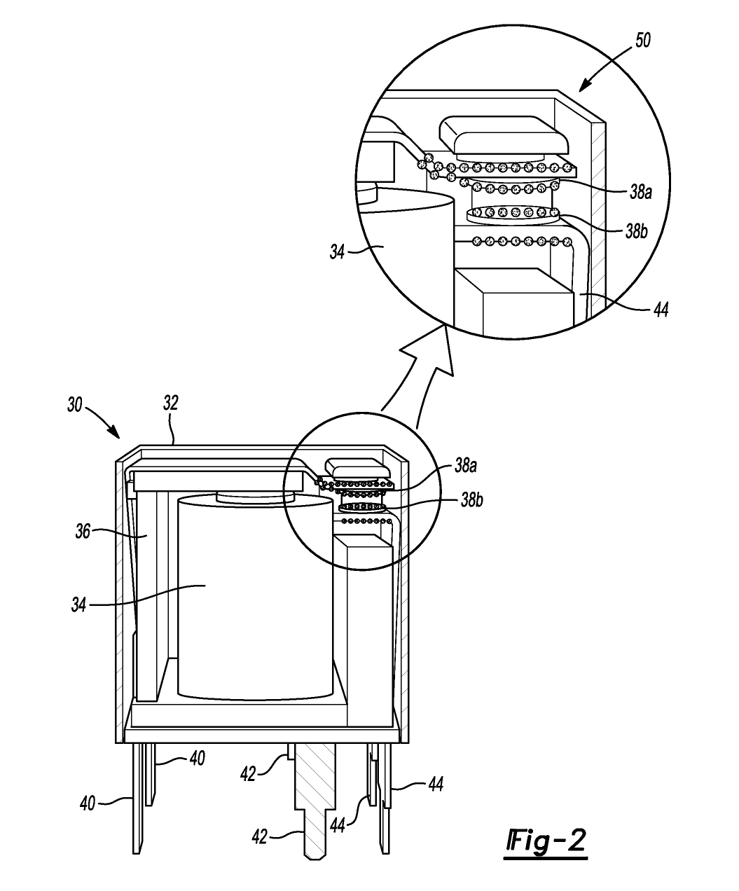

FIG. 2 depicts another view of a relay 30 and the manner in which the relay 30 may become inoperative due to the environment. The relay 30 generally includes a housing 32, a coil 34, an armature 36, and contacts 38a and 38b (or “38”). The relay 30 is generally in a normally open condition (e.g., the contacts 38a and 38b are not in engaged with one another and therefore does not allow current to pass from a power source to a load). As is generally known, the relay 10 is active when current is applied to the coil 34. In response to such current, the coil 34 produces a magnetic field which subsequently causes the armature 36 to move in a downward direction. The movement of the armature 36 causes the contact 38a to also move downward to contact the contact 38b.

The relay 30 includes a first terminal 40 that is integrated with the armature 36 and connected to the contact 38a. The first terminal 40 protrudes from the housing 32. The relay 30 further includes a plurality of second terminals 42 that is electrically coupled to the coil 34 to provide current when it is desired to activate the coil 34 and to cause the contacts 38a, 38b to contact one another. In general, one of the second terminals 42 receives current and provides such current to the coil 34 while the other second terminals 42 receives the current from the coil 34 and provides the the same as an output from the relay 10. The plurality of second terminals 42 also protrudes from the housing 32. The relay 30 further includes a third terminal 44 that protrudes from the housing 32 and that is connected with the second contact 38b.

As noted above, when it is desired for the relay 30 to provide current, the coil 34 is energized (or active). The coil 34 generates heat when the relay 30 is active. However, when the relay 30 is turned off or no longer active, the coil 34 may still be at a higher temperature than the contacts 38 for a predetermined amount of time. In this case, the contacts 38 may reach a colder state and attract moisture or water within the relay 30 once the relay 30 is no longer active (this condition is generally shown at 50). As further exhibited, heat transfer between the coil 34 and the contacts 38 may not be optimal since there is no thermal contact with the third terminal 44 that is coupled to the contact 38.

In general, the housing 32 is a plastic material case that seals the relay 30′. However, such plastic based housings 32 may not provide for a fully hermetic seal and may still provide for a water absorption coefficient (i.e., water absorbs through the plastic and flows internal to the relay 30). For example, external ambient humidity may enter through the various pores of the plastic of the housing 32′ or by other chemical mechanisms. Even the use of more expensive or improved plastic materials may still allow water to pass there through. In general, water absorption may not be avoided if the relay 30 is exposed a high humidity atmosphere for a long period of time. In this case, water vapor may find its way into the relay 30.

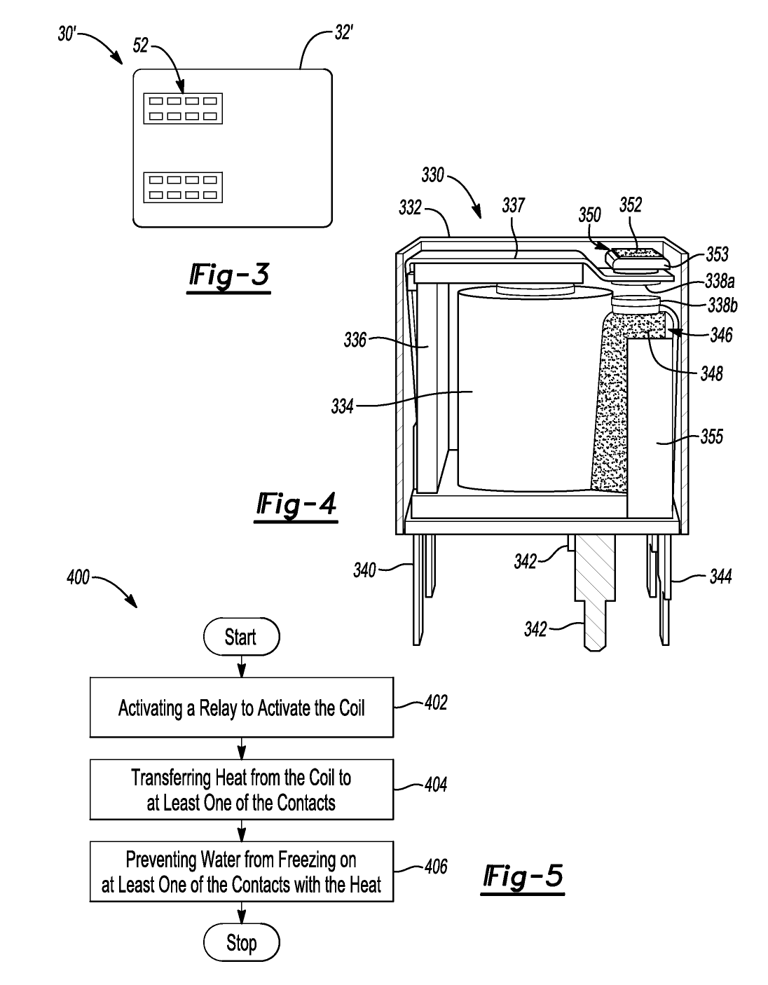

FIG. 3 depicts one conventional implementation of a relay 30′ and a housing 32′. It may not be feasible to provide for a fully hermetic relay such as for example one that utilizes a ceramic or metal housing as such materials may be expensive and add weight to a vehicle. The relay 30′ includes small apertures (or micro-slits) in the housing 32′ as generally shown at 52. Such micro-slits 52 may assist in providing an outlet for water and therefore facilitate a balance of partial pressure between inside of the relay 30′ and the outside ambient of the relay 30′. While micro-slit relays 30′ enables water to travel from within the relay 30′ to the outside environment through the micro-slits 52, such an implementation may still allow for water to intrude the inside the housing 32′. In general, even small amounts of water may still freeze contacts (not shown) within the relay 30′.

FIG. 4 depicts a cross-sectional view of a relay 330 in accordance to one embodiment. The relay 330 generally includes a housing 332, a coil 334, an armature 336, and contacts 338a and 338b (or “338”). The relay 330 also includes a first terminal 340 that is integrated with the armature 336, and the flexing terminal 337, and that is connected to the contact 338a. The first terminal 340 protrudes from an underside of the housing 332. The relay 330 further includes a second terminal 342 that is electrically coupled to the coil 334 to provide current when it is desired to activate the coil 334 and to cause the contacts 338a, 338b to contact one another. The plurality of second terminals 342 also protrudes from the housing 332. The relay 330 further includes a third terminal 344 that protrudes from the housing 332 and that is connected with the second contact 338b. The relay 330 also includes a normally closed contact terminal 353 that is coupled to the flexing terminal 337. The normally closed contact terminal 353 contacts the contact 338a when the relay 330 is off (or deactivated). When the relay 330 is activated, the contact 338a moves away from the normally closed contact terminal 353 to contact the contact 338b to enable current flow from the relay 330.

The coil 334 and the third terminal 344 define an opening 346 there between. A first thermal conductive material (e.g., thermal pad) 348 is positioned within the opening 346 to contact the coil 334 and a portion of the third terminal 344 that may include the contact 338 to transfer heat to the second contact 338b. A first support member 335 may be positioned within the housing 332 or be integral with the housing 332 to support or engage at least one side of the first thermal conductive material 348. It is recognized that the opening 346 may take on any number of sizes of shapes to facilitate receiving and supporting the first thermal conductive material 348. The first thermal conductive material 348 may also comprise thermally conductive foam which improves contact between heat generating electrical components and heat sinks.

In general, the first thermal conductive material 348 may be in thermal communication with the coil 334 and the contacts 338 for transferring heat from the coil 334 to the contacts 338. In one example, the first thermal conductive material 348 may be in direct contact with the coil 334. The coil 334 itself is generally the largest component within the relay 330 and it comprises copper. Once the coil 334 is energized (or activated), the coil 334 heats up. In this case, the coil 334 acts as a thermal storage element as the coil 334 provides for a larger thermal inertia than other components within the relay 330. For example, the coil 334 stores heat for a longer amount of time than the other components within the relay 330. In addition, the coil 334 requires more time than the other components within the relay 330 to cool down. In contrast, each of the contacts 338 generally have a small metal mass and therefore cool down quickly (e.g., this is also facilitated via a metal interface soldered to a PCB with generally copper track surface areas (not shown) in the relay 330).

The relay 330, with the use of the first thermal conductive material 348 may equalize the temperature between the contacts 338 and the coil 334. For example, the heat transfer from the coil 334 to the contacts 338 result in a temperature increase of the contacts 338 which provides for a slower cooling down period for the contacts 338 when the relay 330 is deactivated. This condition prevents water from migrating to the contacts 338 as soon as the relay 330 is deactivated. The water in this case will migrate to other areas within the housing 332 that may exhibit colder temperatures than the contacts 338 once the relay 330 is deactivated. Ultimately, the temperature of the contacts 338 will decrease when all of the heat is fully transferred from the coil 334 and through the first thermal conductive material 348. However, in this case, the water has already migrated to other parts of the relay 330 and the water will not freeze on the contacts 338.

It is recognized that a second thermal conductive material 352 may be added to the relay 330 and be positioned to also directly contact the coil 334. For example, while FIG. 4 illustrates that the first thermal conductive material 348 is coupled to the third terminal 344 and to the second contact 338b, the second thermal conductive material 352 may be in positioned in a cavity 350 that is formed between the coil 334 and the normally closed contact terminal 353. The second thermal conductive material 352 may then be in contact with the plurality of third terminals 344 for transferring heat from the coil 334 to the contact 338a (i.e., when the relay 10 is in standby (or not activated)) to delay the cooling of the contact 338a as noted above. Likewise, the second thermal conductive material 352 may be formed, shaped, or configured to contact the normally closed contact terminal 353 to transfer heat from the coil 334 to the contact 338a when the relay 330 is deactivated. In addition, the second thermal conductive material 352 may be combined or formed to be integral with the first thermal conductive material 348. In general, each of the first thermal conductive material 348 and the second thermal conductive materials 352 may be comprised of a grease based material or a polymer with added fillers of ceramic, graphite particles, etc.

FIG. 5 depicts a method 400 for preventing the relay 330 from freezing in accordance to one embodiment.

In operation 402, the relay 330 is activated thus activating the coil 334. The coil 334 provides current as received through the plurality of second terminals 342 (from a power source outside of the relay 330) and generates heat in response to the current.

In operation 404, the first thermal conductive material 348 and/or the second thermal conductive material 352 transfers heat from the coil 334 to at least one of the contacts 338.

In operation 406, at least one of the contacts 338 are heated to prevent water from freezing (or condensing) on the contact 338. As noted above, the heating of the contact 338 prevents the contact 338 from freezing faster than other components within the relay 330 after the relay 330 is deactivated (or the vehicle is shut down). Thus, water migrates to other sections of the relay 330 as such sections are cooler than the contact 338. This thermal delay (or slower cooling down period) with respect to the contact(s) 338 prevents water from migrating to the contacts 338 once the relay 330 is deactivated.

In general, embodiments disclosed herein may transfer heat from the coil to metal contacts to provide a slower temperature decrease on the contacts in relation to the rest of parts (plastics, other metal elements) and thus divert condensation from the contacts to other surfaces. By the time the contacts get cool enough, the ambient air will have reduced the moisture to an “acceptable” level such that little to no condensation will occur on the contacts.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus comprising:
a relay including:
a coil that generates heat in response to a current;
a terminal including a first contact positioned thereon, wherein the coil and the terminal define a cavity there between; and
a thermal conductive material being positioned in the cavity and being in thermal communication with the coil and the first contact to transfer the heat from the coil to the contact.

2. The apparatus of claim 1 wherein the relay is configured to be positioned in a vehicle.

3. The apparatus of claim 1 wherein the relay further includes a housing to receive the coil, at least a portion of the terminal, the first contact, and the thermal conductive material.

4. The apparatus of claim 1 wherein the thermal conductive material directly contacts the coil.

5. The apparatus of claim 4 wherein the thermal conductive material directly contacts the terminal to transfer the heat from the coil to the first contact.

6. The apparatus of claim 1 wherein the thermal conductive material comprises one of a grease based material and a polymer including fillers of one of ceramic and graphite particles.

7. An apparatus comprising:
a relay including:
a coil that generates heat in response to a current;
a first terminal including a first contact positioned thereon, wherein the coil and the first terminal define a cavity there between;
a second terminal includes a second contact positioned thereon, and
a thermal conductive material being positioned in the cavity and being in thermal communication with the coil and at least one of the first contact and the second contact to transfer the heat from the coil to the at least one of the first contact and the second contact and to prevent water from condensing on the least one of the first contact and the second contact.

8. The apparatus of claim 7 wherein the relay is configured to be positioned in a vehicle.

9. The apparatus of claim 7 wherein relay further includes a housing to receive the coil, at least a portion of the first terminal, the first contact, and the thermal conductive material.

10. The apparatus of claim 7 wherein the thermal conductive material directly contacts the coil.

11. The apparatus of claim 10 wherein the thermal conductive material directly contacts the first terminal to transfer the heat from the coil to the first contact.

12. The apparatus of claim 7 wherein the thermal conductive material comprises one of a grease based material and a polymer including fillers of one of ceramic and graphite particles.

13. A method for comprising:
activating a coil in a relay to generate heat from the coil;
thermally conducting the heat from the coil with a thermal conductive material;
transferring the heat from the thermal conductive material to a first terminal; and
transferring the heat from the first terminal to a first contact.

14. The method of claim 13 further comprising positioning the relay in a vehicle.

15. The method of claim 13 further comprising receiving, at a housing of the relay, at least a portion of the first terminal, the first contact and the thermal conductive material.

16. The method of claim 13 further comprising directly contacting the thermal conductive material with the coil prior to thermally conducting the heat from the coil with the thermal conductive material.

17. The method of claim 16 further comprising directly contacting the thermal conductive material to the first terminal prior to transferring the heat from the thermal conductive material to the first terminal.
